(19) United States
(12) Patent Application Publication
(10) Pub. No.: US 2007/0160904 A1
(43) Pub. Date: Jul. 12, 2007

(54) Battery and method of making the same

(76) Inventor: Hwa Il Uh, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/651,522

(22) Filed: Jan. 10, 2007

(30) Foreign Application Priority Data
Jan. 11, 2006 (KR) 2006-0003251

(51) Int. Cl. H01M 2/08; H01M 2/06; H01M 2/26

(52) U.S. Cl. 429/174; 429/181; 429/161

(57) ABSTRACT

A battery includes a case having an opening, an electrode assembly disposed in the case and having first and second electrode tabs extending therefrom, and a cap assembly covering the opening in the case, the cap assembly including an insulation case disposed adjacent to the electrode assembly, the insulation case having an anti-deformation portion and first and second electrode tab holes, wherein the first and second electrode tabs extend through the first and second electrode tab holes, respectively.

### BACKGROUND OF THE INVENTION

1. Field of the Invention

The present invention relates to a battery. More particularly, the present invention relates to a battery configured to tolerate compression applied thereto, and a method of making the same.

2. Description of the Related Art

Recently, compact and light electrical/electronic devices, including, e.g., cellular phones, laptop computers, camcorders, etc., have been actively developed and produced. These portable devices may be equipped with a battery pack so that they can be operated when a separate power supply is unavailable. The battery pack may contain one or more batteries that output a predetermined level of voltage, so that the portable devices can be powered for a predetermined period of time without being connected to the separate power supply.

Battery types generally include primary, or single-use, and secondary, or rechargeable, batteries. Secondary batteries offer an economical way to provide portable devices with power, since they can be recharged multiple times. Examples of electrochemical technologies employed in secondary batteries include, e.g., nickel-cadmium (Ni—Cd) batteries, nickel metal hydride (Ni-MH) batteries, lithium (Li) batteries, lithium ion batteries, etc.

For lithium-based secondary batteries, lithium-based oxide and carbon are commonly used as the electrode positive and negative active materials, respectively. Lithium secondary batteries may be generally classified, based on the type of electrolyte employed, into lithium ion batteries, which use a liquid electrolyte, and lithium polymer batteries, which use a polymer electrolyte. In addition, lithium secondary batteries may be manufactured in various form factors, e.g., cylindrical, prismatic, pouch, etc.

Lithium-based secondary batteries may exhibit an operating voltage of about 3.6V, which is generally three times greater than that of comparable Ni—Cd batteries or Ni-MH batteries. Lithium-based batteries may also exhibit a high energy density per unit weight. For these reasons, they are increasingly used in the industry.

Batteries, particularly those having a high energy density and/or a high operating voltage, may present risks to the device being powered and/or people if the batteries become damaged. For example, if the battery is damaged, battery electrodes inside the battery may short-circuit, which may cause, e.g., rapid heat buildup, leakage, fire, explosion, etc.

### SUMMARY OF THE INVENTION

The present invention is therefore directed to a battery and a method of making the same, which substantially overcome one or more of the problems due to the limitations and disadvantages of the related art.

It is therefore a feature of an embodiment of the present invention to provide a battery having an insulation case through which an electrode tab passes, the insulation case configured to resist deformation when the battery is subjected to an externally-applied compressive force.

It is therefore another feature of an embodiment of the present invention to provide a battery having an insulation case that includes an anti-deformation portion disposed adjacent to an electrode tab hole in the insulation case, the anti-deformation portion helping to prevent deformation of the electrode tab hole.

At least one of the above and other features and advantages of the present invention may be realized by providing a battery including a case having an opening, an electrode assembly disposed in the case and having first and second electrode tabs extending therefrom, and a cap assembly covering the opening in the case, the cap assembly including an insulation case disposed adjacent to the electrode assembly, the insulation case having an anti-deformation portion and first and second electrode tab holes, wherein the first and second electrode tabs extend through the first and second electrode tab holes, respectively.

The battery may further include an electrode terminal welded to the first electrode tab, the electrode terminal passing through the cap assembly. The first electrode tab hole may define an opening through which the first electrode tab passes, the opening having an area substantially larger than a cross-sectional area of the first electrode tab, such that the first electrode tab may be spaced apart from a periphery of the opening when the first electrode tab is inserted through the opening. The anti-deformation portion may include a support piece disposed on a side of the first electrode tab hole. The support piece may connect a side of the first electrode tab hole to an opposite side of the first electrode tab hole so as to divide the first electrode tab hole into two parts. The anti-deformation portion may further include a reinforcement rib disposed along at least a part of a periphery of the first electrode tab hole.

The anti-deformation portion may include a reinforcement rib disposed along at least a part of a periphery of the first electrode tab hole. The insulation case may have a rib extending along a periphery thereof, and the rib and the reinforcement rib may have a same height. An anti-deformation portion may be provided for each of the first and second electrode tab holes. The battery case may be a prismatic case.

At least one of the above and other features and advantages of the present invention may be realized by providing a battery including a case having an opening, an electrode assembly disposed in the case and having at least one electrode tab extending therefrom, and a cap assembly covering the opening in the case, the cap assembly including an insulation case disposed adjacent to the electrode assembly, the insulation case having an electrode tab hole therein, the at least one electrode tab extending through the electrode tab hole, wherein the insulation case includes a means for preventing deformation of the electrode tab hole disposed at a periphery of the electrode tab hole.

The means for preventing deformation of the electrode tab hole may prevent elongation of the electrode tab hole.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a battery according to an embodiment of the present invention;

FIG. 2 illustrates a top plan view of an insulation case of the battery of FIG. 1;

FIG. 3 illustrates a sectional view of the assembled battery of FIG. 1;

FIG. 4 illustrates a top plan view of an insulation case of a battery according to another embodiment of the present invention; and

FIG. 5 illustrates a sectional view taken along line V-V of FIG. 4.

### DETAILED DESCRIPTION OF THE INVENTION

Korean Patent Application No. 2006-0003251, filed on Jan. 11, 2006, in the Korean Intellectual Property Office, and entitled: “Secondary Battery,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred-to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A battery according to an embodiment of the present invention will be now be described. In the description that follows, particular examples will be referred to in order to provide a clear understanding of the present invention. However, it will be appreciated that embodiments of the present invention are not restricted to these particular examples. Thus, for example, aspects of the following description describe a prismatic secondary battery. However, embodiments of the present invention are not limited thereto, and may be applied to, e.g., primary batteries, cylindrical batteries, etc.

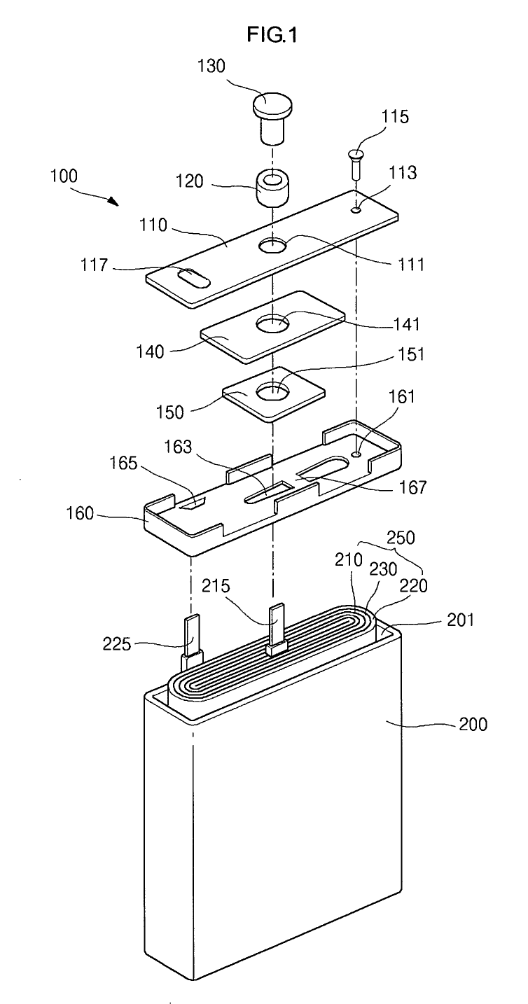

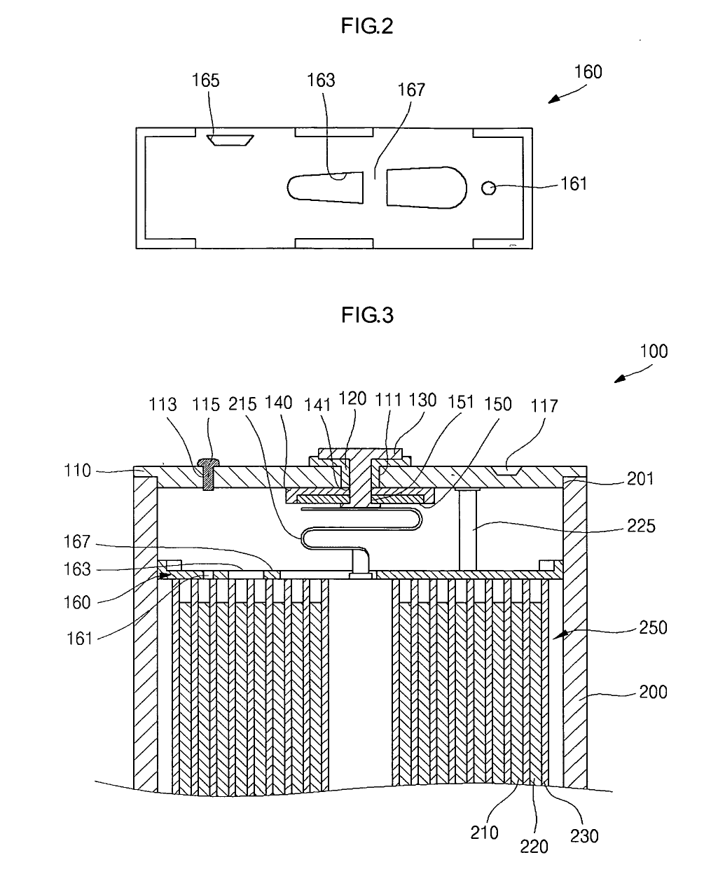

FIG. 1 illustrates an exploded perspective view of a battery according to an embodiment of the present invention, FIG. 2 illustrates a top plan view of an insulation case of the battery of FIG. 1, and FIG. 3 illustrates a sectional view of the assembled battery of FIG. 1. Referring to FIGS. 1-3, a battery may be a bare cell including a case 200, an electrode assembly 250 contained inside the case 200, and a cap assembly 100 coupled to an opening 201 of the case 200 to seal the top of the case 200. The battery may be, e.g., a secondary battery.

The battery case 200 may be metal, e.g., aluminum or aluminum alloy, and may be rectangular. The electrode assembly 250 may be placed into the case 200 via the opening 201. The case 200 may act as an electrode terminal, i.e., it may be connected to one of a first and second electrode tab 215 and 225 of the electrode assembly 250.

The electrode assembly 250 may be, e.g., a lamination of a first electrode 210, one or more separators 230, and a second electrode 220. The electrodes 210 and 220, and the separator(s) 230, may be wound into a spiral.

The first electrode 210 may be connected to the first electrode tab 215. The second electrode 220 may be connected to the second electrode tab 225. The first and second electrodes 210 or 220 may act as negative and positive electrodes, respectively, although they may be switched depending on the implementation.

Where configured as the negative electrode, the first electrode 210 may be a thin plate or film type electrode, and may include a current collector made of conductive metal foil, e.g., a copper foil, and an active material layer coated on both surfaces of the collector using, e.g., carbon as the main component. The first electrode tab 215, which may be a negative electrode tab, may be connected to a region of the first electrode 210 which has no active material thereon. The first electrode tab 215 may be extended upwards from the first electrode 210, i.e., towards the cap assembly 100.

Where configured as the positive electrode, the second electrode 220 may include a current collector made of metal foil having excellent electrical conductivity, e.g., aluminum foil, and an active material layer coated on both surfaces of the collector using, e.g., a lithium-based oxide as the main component. The second electrode tab 225, which may be a positive electrode tab, may be electrically connected to a region of the second electrode 220 which has no positive electrode active material thereon. The second electrode tab 225 may be extended upwards from the second electrode 220.

The separator 230 may be made of an insulator, e.g., polyethylene, polypropylene, a copolymer of polyethylene and polypropylene, etc. The separator 230 may have a width larger than the width of the first and second electrodes 210 and 220, which may help avoid a short circuit between the first and second electrodes 210 and 220.

The cap assembly 100 may be adapted to close and seal the opening 201 of the case 200. The cap assembly 100 may include a flat cap plate 110 having a size and a shape corresponding to the size and shape of the opening 201. The cap assembly 100 may also include an insulation plate 140 positioned adjacent to the lower surface of the cap plate 110, and a terminal plate 150 positioned adjacent to the lower surface of the insulation plate 140. The terminal plate 150 may be electrically connected to the first electrode tab 215 and, thus, to the first electrode 210.

The cap plate 110 may have a first terminal hole 111 formed therein, e.g., in the center thereof, in order to accommodate a first electrode terminal 130. The first electrode terminal 130 may extend through the cap plate 110 and may be connected to the first electrode tab 215. A tubular gasket 120 may be positioned in the first terminal hole 111 and around the first electrode terminal 130, in order to electrically insulate the first electrode terminal 130 from the cap plate 110.

The cap plate 110 may have an electrolyte injection hole 113 formed therein, e.g., at a side thereof. The electrolyte injection hole 113 may be used to inject electrolyte into the interior of the battery after the cap assembly 100 is assembled to the opening 201 of the case 200. After the electrolyte is injected, the electrolyte injection hole 113 may be sealed by a plug 115.

The insulation plate 140 may be made of a same insulation material as the gasket 120. The insulation plate 140 may be coupled to the lower surface of the cap plate 110 and may have a second terminal hole 141 formed therein that corresponds to and communicates with the first terminal hole 111 in the cap plate 110.

The terminal plate 150 may be made of a metal, e.g., nickel (Ni) metal or a Ni alloy, and may be coupled to the lower surface of the insulation plate 140. The terminal plate 150 may have a third terminal hole 151 formed therein that corresponds to the first terminal through 111 in the cap plate 110.

The insulation case 160 may be positioned on top of the electrode assembly 250 to insulate the electrode assembly 250 from the cap plate 110.

The insulation case 160 may be made of a high-molecular resin having insulation properties, e.g., polypropylene. The insulation case 160 may have first and second electrode tab holes 163 and 165 located such that the respective first and second electrode tabs 215 and 225 can project from the top of the electrode assembly 250 through the holes 163 and 165.

The insulation case 160 may have an electrolyte injection hole 161 formed therein, e.g., at a side thereof. The electrolyte injection hole 161 may be aligned with the electrolyte injection hole 113 that is formed in the cap plate 110.

One of the first and second electrode tabs 215 and 225 may act as a negative electrode tab. For example, the first electrode tab 215 may act as the negative electrode tab.

Assembly of the battery may require that the first electrode tab 215 be welded to the first electrode terminal 130. To this end, the first electrode tab hole 163, through which the first electrode tab 215 extends, may be configured to have a size large enough to enable the electrode terminal 130 and the first electrode tab 215 to be welded to each other after installation of the insulation case 160. Therefore, the first electrode tab hole 163 may have a size larger than is required merely to accommodate the first electrode tab 215. The second electrode tab hole 165 may be similarly sized with respect to the second electrode tab 225.

During assembly of the battery, e.g., when the cap assembly 110 is pressed against the case 200 to seal it, or during use of the battery by an end user, an externally-applied compressive force may be applied to the battery. Such a force, if applied to the first and/or second electrode tabs 215 and 225, may have a tendency to cause the first and second electrode tab holes 163 and 165 to deform, e.g., to enlarge. This may allow the first and second electrode tabs 215 and 225, which extend through the first and second electrode tab holes 163 and 165, to be displaced in the reverse direction, i.e., inwardly, which may result in an undesired electrical contact with the case 200, the electrode assembly 250, etc. For example, the compressive force could cause the first and/or second electrode tabs 215 and 225 to short-circuit to the case 200 and/or electrode assembly 250 if they are displaced inwardly through the first and second electrode tab holes 163 and 165.

Accordingly, in the battery according to this embodiment of the present invention, one or both of the first and second electrode tab holes 163 and 165 may be provided with an anti-deformation portion, in order to reduce or eliminate the possibility of the holes 163 and 165 becoming deformed. The anti-deformation portion may include a support piece 167 as a feature for reducing the size of the first and second electrode tab holes 163 and 165.

In the case of the first electrode tab hole 163, as shown in FIG. 2, the support piece 167 may be positioned to connect a side of the first electrode tab hole 163 to a second, opposite side of the first electrode tab hole 163. Thus, the first electrode tab hole 163 may be divided into two parts by the support piece 167.

A procedure for assembling the battery constructed as above according to this embodiment of the present invention will now be described. The electrode assembly 250 may be placed into the case 200, and the insulation case 160, which has the support piece 167 formed thereon, may be placed on top of the electrode assembly 250. The first and second electrode tabs 215 and 225 may be drawn from the electrode assembly 250 through the first and second electrode tab holes 163 and 165 formed in the insulation case 160.

The cap plate 110, the insulation plate 140 and the terminal plate 150 may be successively stacked on one another in such a manner that their respective first, second, and third terminal holes 111, 141 and 151 are in communication with one another. The electrode terminal 130 may be inserted into the first, second, and third terminal holes 111, 141 and 151 by rotating it with a predetermined force, so that it extends through the cap plate 110, the insulation plate 140 and the terminal plate 150.

The electrode terminal 130 may extend through the first terminal hole 111 of the cap plate 110 while being insulated from the cap plate 110 by the gasket 120, so that the terminal plate 150 is electrically connected to the electrode terminal 130 while being insulated from the cap plate 110.

After being assembled in this manner, the cap assembly 100 may seal the opening 201 of the case 200, and the first and second electrode tabs 215 and 225 may be connected to the electrode terminal 130 and the cap plate 110, respectively.

The support piece 167 of the first and/or second electrode tab holes 163 and 165 may help prevent the first and second electrode tabs 215 and 225 from being displaced in the reverse direction when subjected to external compression.

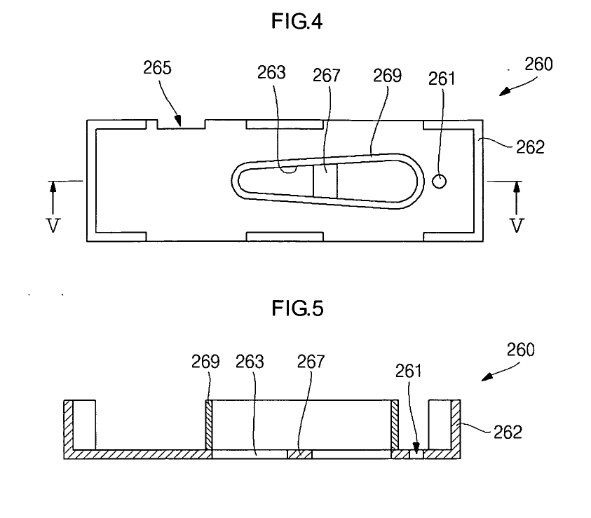

FIG. 4 illustrates a top plan view of an insulation case of a battery according to another embodiment of the present invention, and FIG. 5 illustrates a sectional view taken along line V-V of FIG. 4. Referring to FIGS. 4 and 5, a battery according to this embodiment of the present invention may be similar to the first embodiment, as described above, and may include an insulation case 260 having a reinforcement rib 269 formed along a periphery of an electrode tab hole 263.

The reinforcement rib 269 may be integral with an insulation case 260 by forming it in, e.g., an injection process, together with a rib 262 on a peripheral edge of the insulation case 260. The reinforcement rib 269 and the rib 262 on the peripheral edge may be simultaneously formed and may protrude upwards from the upper surface of the insulation case 260 by a same height.

The reinforcement rib 269 may be formed around the hole 263 and may protrude vertically from the surface of the insulation case 260. The reinforcement rib 269 may act as support member to reduce or eliminate the possibility of the periphery of the hole 263 being deformed if an external force acts on the insulation case, particularly, on the periphery of hole 263, in the vertical direction. In addition to helping prevent deformation of the hole 263 and the insulation case 260, the reinforcement rib 269 may help prevent the hole 263 from widening. As a result, the upper portion of an electrode tab (not shown in FIGS. 4 and 5), which may be positioned above the insulation case 260 through the hole 263, may be supported by the insulation case 260, which may resist deformation even when the external force acts on it from above. Accordingly, one or both electrode tab holes 263 and 265 may be prevented from being deformed and widened, which may reduce the possibility that the electrode tabs are displaced in the reverse direction via the holes 263 and 265 to short-circuit to the electrode portions of the electrode assembly.

As described above, a battery according to an embodiment of the present invention may include an insulation case having an anti-deformation portion, which may help reduce or eliminate deformation when the battery is subjected to external compression. In particular, one or both of the first and second electrode tab holes, through which the first and second electrode tabs project, may be provided with a support piece crossing the opening so that, even when the battery is subjected to external compression, the first and second electrode tabs are not displaced inwardly to contact the electrode assembly, etc.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims. For example, it will be understood that embodiments of the present invention may be applied to one or both of the first and second electrode tab holes, and that the first and second electrode tab holes may correspond to a positive electrode tab or a negative electrode tab. Further, it will be appreciated that embodiments of the present invention may be used alone or in combination. Thus, for example, the reinforcement rib may be formed together with the support piece traversing the hole, or each may be employed individually.

What is claimed is:

1. A battery, comprising:
a case having an opening;
an electrode assembly disposed in the case and having first and second electrode tabs extending therefrom; and
a cap assembly covering the opening in the case, the cap assembly including an insulation case disposed adjacent to the electrode assembly, the insulation case having an anti-deformation portion and first and second electrode tab holes, wherein the first and second electrode tabs extend through the first and second electrode tab holes, respectively.

2. The battery as claimed in claim 1, wherein the battery further comprises an electrode terminal welded to the first electrode tab, the electrode terminal passing through the cap assembly.

3. The battery as claimed in claim 1, wherein the first electrode tab hole defines an opening through which the first electrode tab passes, the opening having an area substantially larger than a cross-sectional area of the first electrode tab, such that the first electrode tab is spaced apart from a periphery of the opening when the first electrode tab is inserted through the opening.

4. The battery as claimed in claim 1, wherein the anti-deformation portion includes a support piece disposed on a side of the first electrode tab hole.

5. The battery as claimed in claim 4, wherein the support piece connects a side of the first electrode tab hole to an opposite side of the first electrode tab hole so as to divide the first electrode tab hole into two parts.

6. The battery as claimed in claim 4, wherein the anti-deformation portion further includes a reinforcement rib disposed along at least a part of a periphery of the first electrode tab hole.

7. The battery as claimed in claim 1, wherein the anti-deformation portion includes a reinforcement rib disposed along at least a part of a periphery of the first electrode tab hole.

8. The battery as claimed in claim 7, wherein the insulation case has a rib extending along a periphery thereof, and the rib and the reinforcement rib have a same height.

9. The battery as claimed in claim 1, wherein an anti-deformation portion is provided for each of the first and second electrode tab holes.

10. The battery as claimed in claim 1, wherein the battery case is a prismatic case.

11. A battery, comprising:
a case having an opening;
an electrode assembly disposed in the case and having at least one electrode tab extending therefrom; and
a cap assembly covering the opening in the case, the cap assembly including an insulation case disposed adjacent to the electrode assembly, the insulation case having an electrode tab hole therein, the at least one electrode tab extending through the electrode tab hole, wherein the insulation case includes a means for preventing deformation of the electrode tab hole disposed at a periphery of the electrode tab hole.

12. The battery as claimed in claim 11, wherein the means for preventing deformation of the electrode tab hole prevents elongation of the electrode tab hole.
